(19) United States
(12) Patent Application Publication
(10) Pub. No.: US 2025/0390362 A1
(43) Pub. Date: Dec. 25, 2025

(54) EFFICIENT CONTEXT-BASED EVENT LOG ENRICHMENT

(71) Applicant: AppOmni, Inc., San Francisco, CA (US)

(72) Inventor: Michael Brancato, Lexington, KY (US)

(21) Appl. No.: 18/750,613

(22) Filed: Jun. 21, 2024

(51) Int. Cl. G06F 9/54

(52) U.S. Cl. CPC G06F 9/542

(57) ABSTRACT

Efficient context-based event log enrichment is disclosed, including: extracting a set of values and corresponding contexts from a plurality of event logs; sending respective enrichment requests that each includes the set of values to a set of enrichment target servers; receiving respective enrichment responses from at least a portion of the set of enrichment target servers; and inserting at least a portion of the respective enrichment responses into a portion of the plurality of event logs based at least in part on the corresponding contexts of the set of values.

### BACKGROUND OF THE INVENTION

Service systems may generate logs to document the occurrence of activities, updates in user or application configurations, and/or potential security alerts. Such logs can be consumed by downstream threat detection services for analysis. In some instances, before the logs are analyzed, the logs are first enriched by sending content extracted from the logs to enrichment services, over a network, and/or enrichment information was retrieved from local databases. An enrichment service may provide additional, relevant information to content that is extracted from the logs to improve the downstream analysis of the logs.

Individual values are extracted from logs and then, typically, an enrichment lookup request to an enrichment service is made per value. When there is a large number of values that are extracted from the logs, then there may be a correspondingly large volume of enrichment lookup requests to make. As such, the conventional querying of enrichment services is undesirably resource intensive.

### BRIEF DESCRIPTION OF THE DRA WINGS

Various embodiments of the invention are disclosed in the following detailed description and the accompanying drawings.

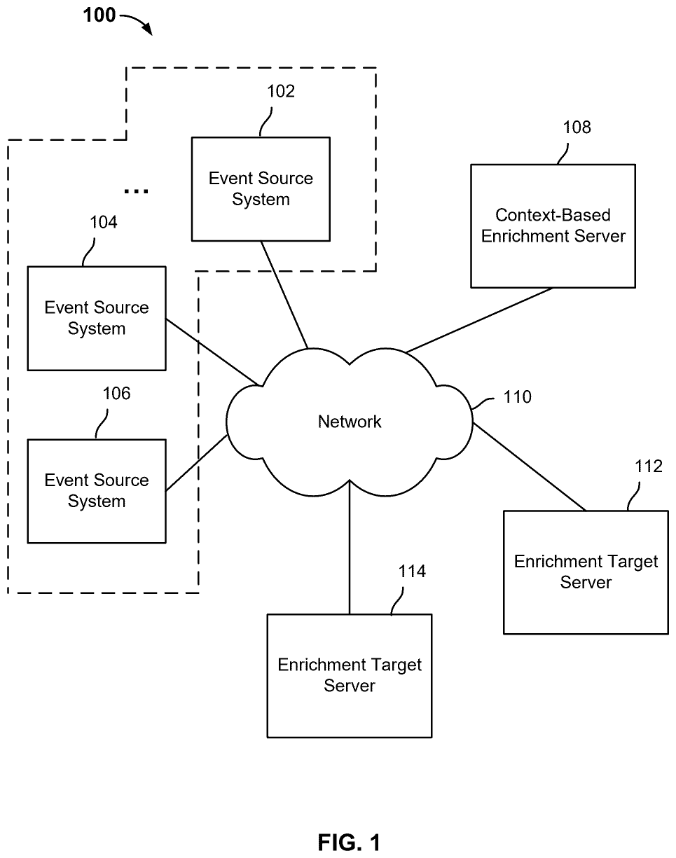

FIG. 1 is a diagram showing an embodiment of a system for efficient context-based event log enrichment.

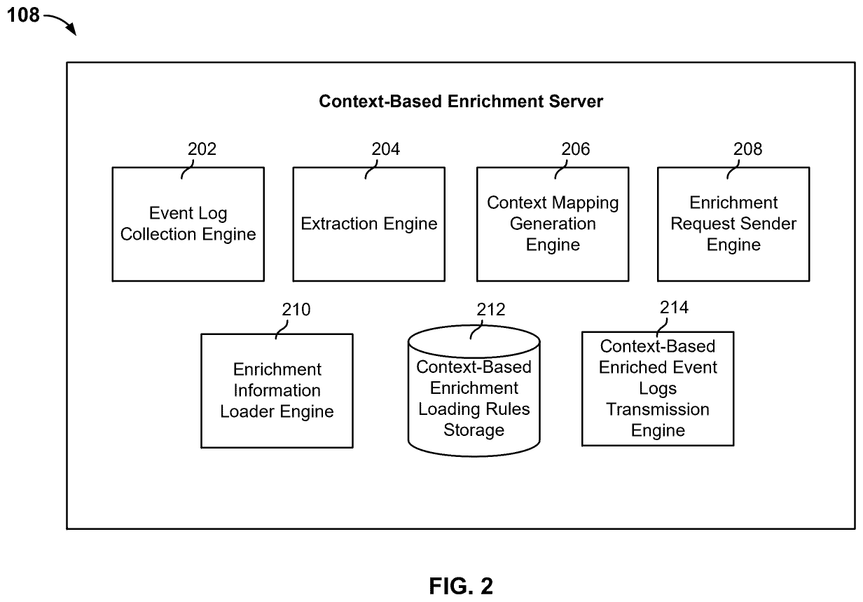

FIG. 2 is a diagram showing an example of a context-based enrichment server in accordance with some embodiments.

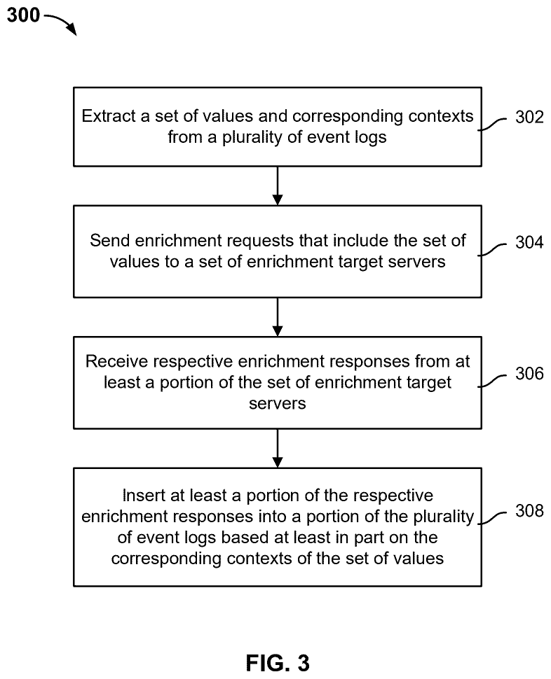

FIG. 3 is a flow diagram showing an embodiment of a process for efficient context-based event log enrichment.

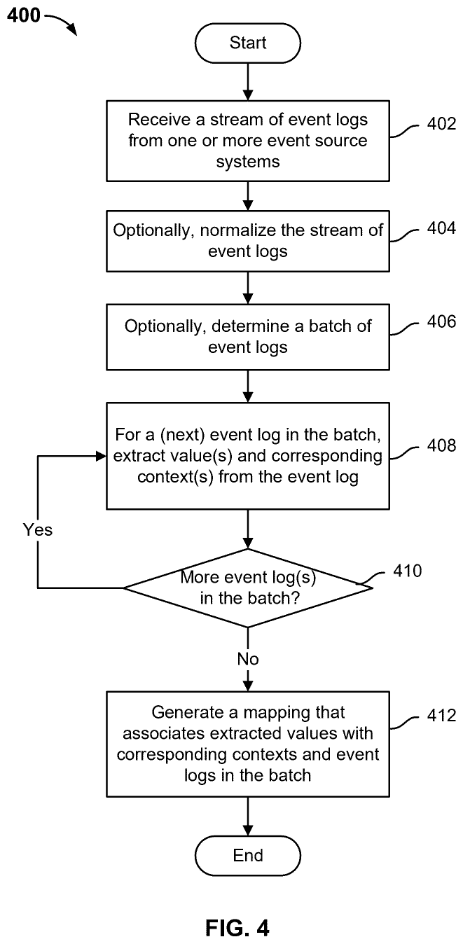

FIG. 4 is a flow diagram showing an example process for extracting values and corresponding contexts from event logs in accordance with some embodiments.

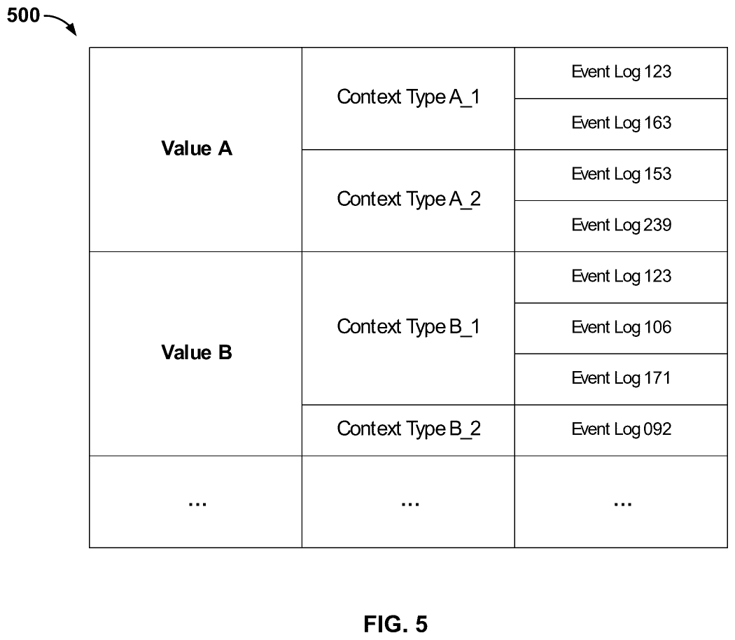

FIG. 5 is a diagram showing an example table including mapping information associated with values that were extracted from a batch of event logs.

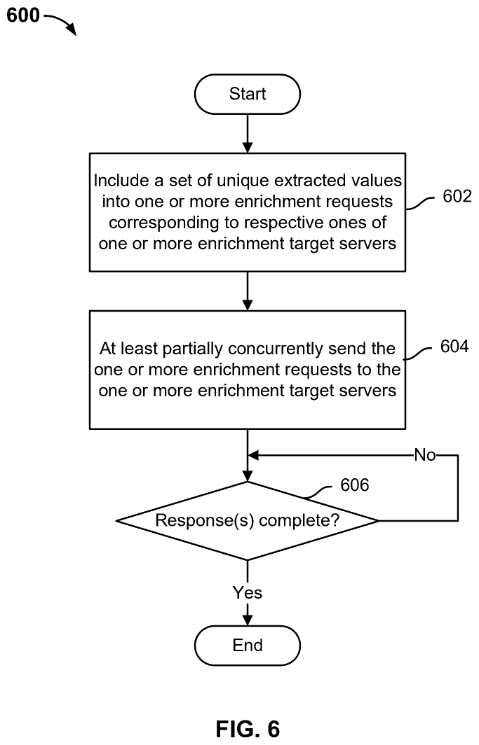

FIG. 6 is a flow diagram showing an example process for sending enrichment requests to a set of enrichment target servers in accordance with some embodiments.

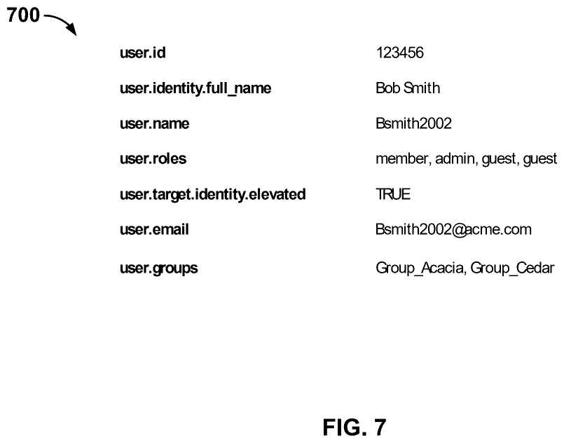

FIG. 7 is a diagram showing an example process enriched user object in accordance with some embodiments.

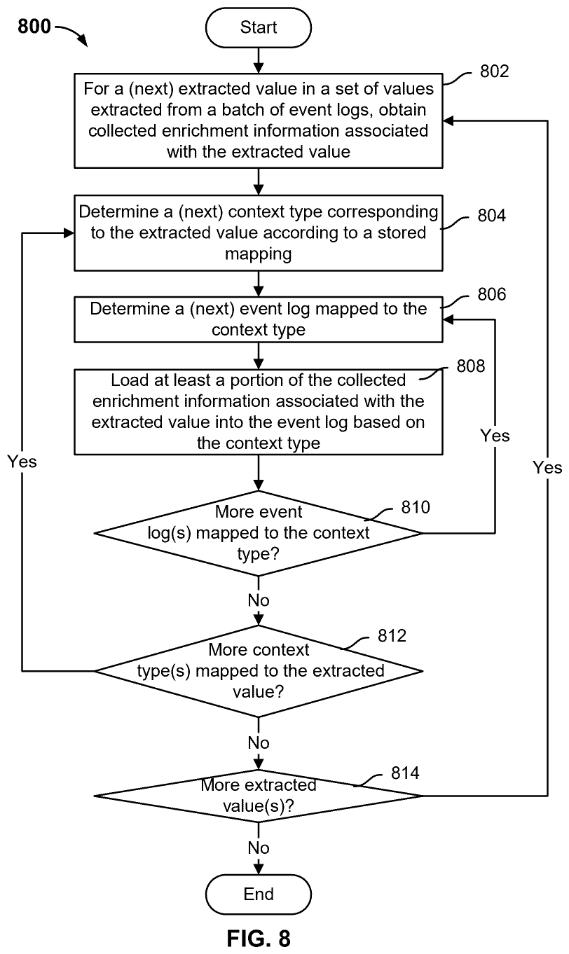

FIG. 8 is a flow diagram showing an example process for loading enrichment information into event logs in accordance with some embodiments.

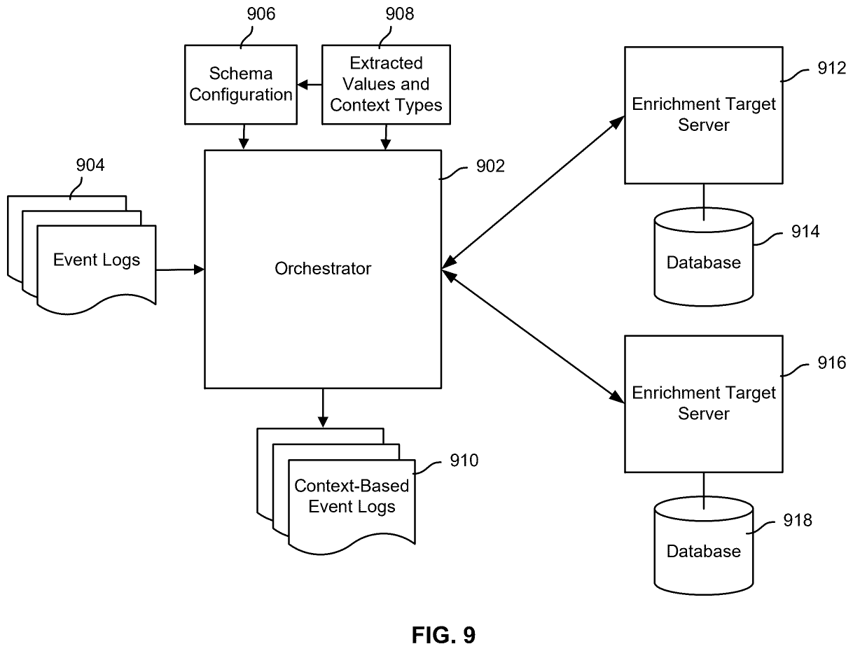

FIG. 9 is a diagram showing an example schematic of a system for efficient context-based event log enrichment in accordance with some embodiments.

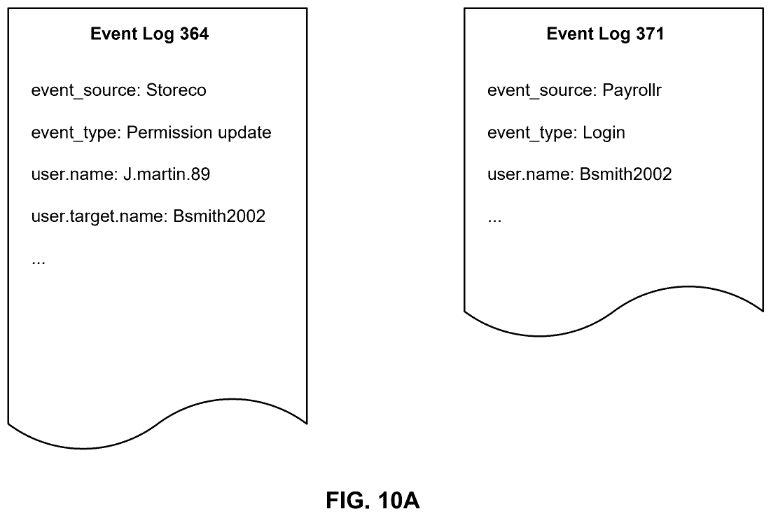

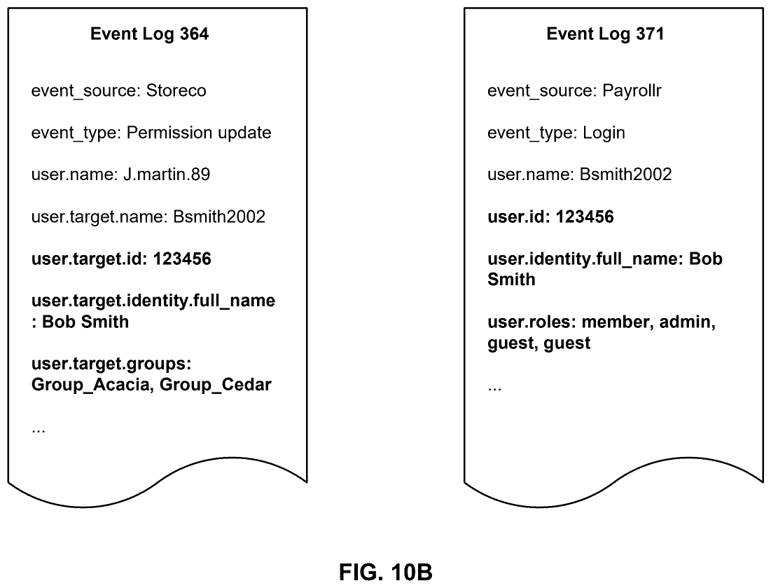

FIG. 10A shows two example event logs prior to context-based enrichment.

FIG. 10B shows two example event logs after context-based enrichment.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of efficient context-based event log enrichment are described herein. A set of values and corresponding contexts are extracted from a plurality of event logs. In some embodiments, values that match one or more predetermined value types are extracted. In some embodiments, the context in which a corresponding value appears within an event log is also extracted. Enrichment requests that include the set of values are sent to a set of enrichment target servers. In some embodiments, the set of extracted values are sent (e.g., at least concurrently) to one or more respective enrichment target servers according to the value types. Respective enrichment responses are received from at least a portion of the set of enrichment target servers. In some embodiments, an enrichment response comprises a set of enriched information (e.g., an enriched object type) that includes at least one enriched field corresponding to an extracted value. At least a portion of the respective enrichment responses are inserted into a portion of the plurality of event logs based at least in part on the corresponding contexts of the set of values. In some embodiments, a corresponding portion of the set of enrichment information that corresponds to an extracted value is selected based on each context associated with that value. The selected corresponding portion of the set of enrichment information that corresponds to the extracted value is then inserted into the event log from which that value was extracted with that particular context.

FIG. 1 is a diagram showing an embodiment of a system for efficient context-based event log enrichment. System 100 includes event source system 102, event source system 104, event source system 106, context-based enrichment server 108, network 110, enrichment target server 112, and enrichment target server 114. Network 110 may be implemented using data networks and/or telecommunication networks. Event source system 102, event source system 104, event source system 106, context-based enrichment server 108, enrichment target server 112, and enrichment target server 114 may communicate to each other over network 110.

Each of event source systems 102, 104, and 106 is configured to provide a respective service and also generate events that document activities (e.g., user activity, a telemetric reading, or a sensed value) that occur with respect to their services/function. In various embodiments, each event includes one or more of the following: an event timestamp associated with when a corresponding activity occurred and/or when the event was generated, a unique identifier for the event, a field that identifies one or more users associated with the activity, a field that describes a role of the one or more users associated with the activity, a field that describes an Internet Protocol address associated with the activity, a field that identifies an organization associated with the activity, and one or more fields that describe attributes of the activity. In various embodiments, at least some of event source systems 102, 104, and 106 are associated with different SaaS platforms. Examples of services provided by SaaS platforms include workflow management, file storing, file sharing, customer relationship management, payroll management, employee data management, human resource data management, and financial management. For example, organizations such as enterprises may subscribe to services provided by one or more SaaS platforms to help manage their businesses. As activities are performed by users (e.g., employees, contractors, customers, and/or guests) associated with an organization that subscribes to the services provided by an event source system (e.g., such as one of event source systems 102, 104, and 106), the event source system is configured to generate corresponding events that document such activities.

Context-based enrichment server 108 is configured to obtain the event logs from the streams of events that are generated by one or more event source systems (e.g., such as one of event source systems 102, 104, and 106) for one or more organizations. In some embodiments, event logs that are originated by different event source systems may include originally different formatting but are already normalized into a uniform format before they are received at context-based enrichment server 108. In some embodiments, event logs that are originated by different event source systems may include different formatting and these different formats are understood by context-based enrichment server 108. In some embodiments, context-based enrichment server 108 is configured to receive a batch of event logs from one or more event source systems (e.g., the originating event source system had batched together one or more event logs and then sent the batch to context-based enrichment server 108). In some embodiments, context-based enrichment server 108 is configured to determine a batch of event logs by waiting for the arrival of one or more event logs according to a given set of batching criteria (e.g., batching together event logs that are received within each interval of time). Context-based enrichment server 108 is then configured to extract one or more values from each event log (e.g., in the batch of event logs) according to a set of predetermined value types. Examples of value types include user identifier (ID), user name, email address, and IP address. In addition to extracting values according to predetermined value types, context-based enrichment server 108 is also configured to extract, from each event log, a context corresponding to each value extracted from that event log. Different possible types of contexts can be extracted for each value depending on the value's type. For example, possible context types corresponding to a value with the value types of user ID, user name, and email address may be “target” (e.g., the user identified by the user ID/user name/email address is a target of the activity recorded by the event log) or “source” (e.g., the user identified by the user ID/user name/email address is the actor that caused the activity recorded by the event log). In another example, possible context types corresponding to a value with the value type of IP address may be “source” (e.g., the IP address is associated with the origin of the activity recorded by the event log) or “destination” (e.g., the IP address is associated with the outbound target of the activity recorded by the event log). In some embodiments, the context type for an extracted value can be determined from the location within the event log from which the value was extracted and/or the field name of the extracted value in the event log. For example, a user ID/user name/email address value that is extracted from a path/field name in the event log that is associated with “target user” context type will be assigned the “target user” context type but a user ID/user name/email address value that is extracted from a path/field name in the event log that is associated with “source user” context type will be assigned the “source user” context type. In the event that context-based enrichment server 108 has determined two or more event logs that are associated with a batch, it is possible that at least two event logs in the batch might share the same value. Put another way, the same value may be extracted from two or more event logs in the same batch but each with a potentially different context. Context-based enrichment server 108 is configured to generate a mapping that tracks for each extracted value, one or more corresponding contexts with which it was extracted, and one or more source event log identifiers associated with each such corresponding context. As will be described in further detail below, this mapping will be used by context-based enrichment server 108 to insert the obtained enrichment information associated with an extracted value back into the original, source event log.

Context-based enrichment server 108 is configured to send enrichment requests including the extracted set of values to one or more enrichment target servers such as enrichment target server 112 and enrichment target server 114. Each enrichment target server stores collected enrichment information (e.g., in a database) that can be used to enrich (e.g., supplement, provide relevant attributes for) values extracted from the event logs. In some embodiments, context-based enrichment server 108 is configured to determine which extracted value(s) from the batch of event logs to send to which enrichment target server based on the values' respective types. For example, if enrichment target server 112 were associated with providing identity-related enrichment, then extracted values with value types of user ID, user name, and email address would be included in enrichment requests that are sent over network 110 to enrichment target server 112. Similarly, for example, if enrichment target server 114 were associated with providing IP address-related enrichment, then extracted values with the value type of IP address would be included in enrichment requests that are sent over network 110 to enrichment target server 114. In some embodiments, the same extracted value may be sent in enrichment requests to more than one enrichment target server. In various embodiments, context-based enrichment server 108 is configured to send only one instance of a value extracted from a batch of event logs to a relevant enrichment target server, even if more than once instance of that value was extracted from that batch of event logs. In various embodiments, regardless of the number of enrichment target servers that are to receive enrichment requests including values extracted from the same batch of event logs, context-based enrichment server 108 can send the enrichment requests to the one or more enrichment target servers at least partially in parallel. Put another way, context-based enrichment server 108 can send enrichment requests including values that were extracted from the same batch of event logs at around the same time to one or more different enrichment target servers. By sending multiple enrichment requests over network 110 in parallel, context-based enrichment server 108 can avoid the delays associated with serially sending enrichment requests to respective enrichment target servers, which was conventionally performed.

After responses (e.g., including the requested enrichment information) to the enrichment requests are received from the one or more enrichment target servers, context-based enrichment server 108 is configured to load at least some of the requested enrichment information into the batch of event logs. In some embodiments, for each extracted value that was included in a request to an enrichment target server, the enrichment target server is configured to return a response that comprises an enriched object type. An enriched object type includes one or more enrichment fields that include additional/supplemental values corresponding to the extracted value. In some embodiments, the same type of enriched object can be returned for extracted values corresponding to one or more value types. For example, the same type of enriched object (e.g., the “enriched user object”) is returned for extracted values comprising a user ID, a user name, or an email address. Context-based enrichment server 108 is configured to select at least a subset of at least one of the enrichment fields from each enriched object type corresponding to an extracted value based on a corresponding context with which that value was extracted from an event log in the batch and then load/insert that selected subset of enrichment fields into that event log. In some embodiments, which enrichment fields context-based enrichment server 108 is configured to select from an enriched object type corresponding to an extracted value is dependent on a corresponding context with which the value was extracted and preconfigured rules. Put another way, it is possible for context-based enrichment server 108 to select different sets of enrichment fields from an enriched object type corresponding to the same extracted value for different contexts with which the value was extracted from two or more different event logs.

In some embodiments, context-based enrichment server 108 is configured to load enrichment fields from a first set of enriched object types that were returned from enrichment target server(s) in response to previously transmitted enrichment requests including values extracted from a first batch of event logs, and at the same time, transmit enrichment requests including values extracted from a second batch of event logs. In this manner, context-based enrichment server 108 is able to parallelize the processing of enrichment responses (comprising enriched object types) that were previously requested with the transmission of new enrichment requests with values extracted from a new batch of event logs.

After loading the selected enrichment fields from the responses to enrichment requests/calls into respective event logs based on the extracted values' corresponding contexts, context-based enrichment server 108 is configured to send the enriched event logs to downstream services. One example of such a downstream service is a threat detection service. For example, the threat detection process may evaluate each enriched event log, potentially together with one or more other enriched event logs (e.g., that were received close in time), to determine whether a security threat has likely occurred at an event source system and if so, to send an alert to an administrator. The downstream threat detection service is able to leverage not only the original contents of the event log but also the addition of the loaded/inserted enrichment fields of the event logs to make more accurate and informed security threat determinations.

As described in system 100, context-based enrichment server 108 is configured to improve the efficiency of event log enrichment in several ways. A first way is to look across a batch of two or more event logs for the values to extract. A second way is to send a deduplicated set of values that were extracted from the batch of event logs concurrently to the same enrichment target server. A third way is to send enrichment requests (e.g., including values that were extracted from the same batch of event logs) to two or more enrichment target servers at least partially in parallel. A fourth way is to parallelize the processing of responses to previously sent enrichment requests with the transmission of new enrichment requests. Furthermore, context-based enrichment server 108 is configured to customize the loading/insertion of enrichment fields from responses to enrichment requests back into the event logs from which values were extracted according to the context(s) with which the values were extracted to ultimately create more nuanced, enriched event logs for better downstream consumption.

FIG. 2 is a diagram showing an example of a context-based enrichment server in accordance with some embodiments. In some embodiments, context-based enrichment server 108 of FIG. 1 may be implemented, at least in part, by the example context-based enrichment server described in FIG. 2. The example context-based enrichment server of FIG. 2 includes event log collection engine 202, extraction engine 204, context mapping generation engine 206, enrichment request sender engine 208, enrichment information loader engine 210, context-based enrichment loading rules storage 212, and context-based enriched event logs transmission engine 214. Each of event log collection engine 202, extraction engine 204, context mapping generation engine 206, enrichment request sender engine 208, enrichment information loader engine 210, context-based enrichment loading rules storage 212, and context-based enriched event logs transmission engine 214 may be implemented using software and/or hardware (e.g., including one or more processors and/or storage media).

Event log collection engine 202 is configured to collect a stream of event logs from one or more event source systems (e.g., associated with SaaS platforms). In some embodiments, event log collection engine 202 is configured to poll the event source system(s) for event logs. In some embodiments, the event source system(s) are configured to push event logs to event log collection engine 202. In some embodiments, because event logs that are received from different event source systems may be in different formats, event log collection engine 202 is configured to normalize the event logs according to a normalization schema so that the normalized event logs can share a common format. In some embodiments, the event logs that are originated from different event source systems are normalized prior to being received at event log collection engine 202. In some embodiments, event log collection engine 202 is configured to determine a batch of one or more event logs to be processed together for context-based enrichment according to predetermined batching rules. In a first example, the predetermined batching rules may dictate that any event logs that are collected at event log collection engine 202 within a specified time interval should be included in the same batch of event logs. In a second example, the predetermined batching rules may dictate that any event logs that are collected at event log collection engine 202 that meet a dynamic condition should be included in the same batch of event logs. In a third example, the predetermined batching rules may dictate that similar event logs (e.g., event logs that are received from the same event source system and/or include the user objects) should be included in the same batch of event logs. In some embodiments, event log collection engine 202 is configured to receive batches of event logs from an event source system, where the event source system had already batched the one or more event logs together. In some embodiments, event log collection engine 202 is configured to (e.g., temporarily) store the batches of event logs in memory.

Extraction engine 204 is configured to extract values from the one or more event logs of a batch of event logs according to one or more (e.g., predetermined) value types. For example, the values are extracted by extraction engine 204 based on the format and the schema of the event logs. These extracted values are to be turned into more robust information as part of context-based enrichment as described herein. Because extraction of values can be performed by extraction engine 204 locally at the context-based enrichment server (e.g., without needing to send or receive data over a network), the extraction of values can be performed quickly (e.g., with no delays that could potentially be introduced by a network). In some embodiments, a schema configuration describes each value type with one or more locations (e.g., one or more field names) within an event log to identify where a corresponding value, if one is present, is located. In some embodiments, extraction engine 204 is configured to search through each event log of a batch to determine whether a value associated with one or more predetermined value types (e.g., at the corresponding locations within the event logs according to the schema configuration) can be extracted. Examples of value types include user ID, user name, email address, and IP address. In some embodiments, extraction engine 204 is configured to extract each value from an event log with a corresponding context type. An extracted value's context type represents how the value was used within the event log from which it was extracted. In some embodiments, the schema configuration also prescribes which context type to assign to each value type based on an attribute (e.g., location/field name) with which the value was extracted from within an event log. In a first example, the extracted value of a user ID may have the possible context types of an actor or a target of an operation. In a second example, the extracted value of an IP address may have the possible context types of a source IP address or a destination IP address. As will be described in further detail below, the context type informs where to load/insert enrichment fields returned for an extracted value based on the context type of how the extracted value was used in a particular event log.

Context mapping generation engine 206 is configured to generate a mapping comprising the values extracted from the event logs of a batch, the one or more context types with which each value was extracted, and identifying information of one or more event logs from which each value was extracted with each associated context type. The mapping of extracted values, context types, and event logs is used to load/insert enrichment fields returned by an enrichment target server for an extracted value into the one or more event logs from the batch, as will be described in further detail below.

Enrichment request sender engine 208 is configured to send enrichment requests including the values extracted (e.g., by extraction engine 204) from a batch of event log(s), at least partially in parallel, to one or more enrichment target servers. An enrichment target server provides an external service that takes a list of values and returns a corresponding list of enriched object types. In some embodiments, enrichment request sender engine 208 is configured to determine, for each unique value that is extracted from a batch of event logs, a corresponding enrichment target server to which to send the value in an enrichment request. In some embodiments, an enrichment target server is configured to provide enrichment (e.g., is authoritative on enrichment information) corresponding to one or more specified value types. For example, a first enrichment target server may provide enriched user objects in response to enrichment requests that include the extracted values corresponding to value types of user IDs, user names, and email addresses. Example enrichment fields within an enriched user object include full name, email, user ID, role(s), and group memberships. Whereas, for example, a second enrichment target server may provide enriched IP address objects in response to enrichment requests that include the value type of IP address. Example enrichment fields within an enriched IP address object include country, domain, number, organization name, type, city name, country code, geographic coordinate, postal code, region name, and time zone. In some embodiments, if there are multiple instances of the same value that is extracted from a batch of event logs, then enrichment request sender engine 208 is configured to send only one instance of that value in an enrichment request to a corresponding enrichment target server. In various embodiments, if there is more than one unique value extracted from a batch of event logs to be enriched by the same enrichment target server, enrichment request sender engine 208 is configured to send all such values in a single enrichment request to that enrichment target server or, alternatively, enrichment request sender engine 208 is configured to send, at least partially in parallel, two or more enrichment requests that collectively include all of those values to the enrichment target server. In various embodiments, if the values that are extracted from a batch of event logs are to be enriched by two or more different enrichment target servers, enrichment request sender engine 208 is configured to send, at least partially in parallel, enrichment requests to the two or more different enrichment target servers.

In some embodiments, while the context-based enrichment server keeps track of each context type with which a value was extracted (e.g., via context mapping generation engine 206), such context information is not sent by enrichment request sender engine 208 to enrichment target servers. The purpose being that the same enriched object type may be returned by an enrichment target server once for a particular value that was extracted from a set of events associated with a batch, and then potentially different portions thereof can be inserted in different event logs of the batch under different contexts. This reduces load on the enrichment target services-they only receive one copy of an extracted value (in an enrichment request) irrespective of the number of contexts in which they appeared within a batch of event logs.

Enrichment information loader engine 210 is configured to receive responses (e.g., enriched object types) from one or more enrichment target servers corresponding to enrichment requests that were sent (e.g., by enrichment request sender engine 208) and is also configured to load/insert at least portions of the responses into the event logs. In some embodiments, enrichment information loader engine 210 is configured to wait until responses to all enrichment requests that were sent corresponding to values that were extracted from a batch of event logs are received before loading at least portions of the returned enriched object types into the event logs of the batch. In some embodiments, if an enrichment target server to which an enrichment request was sent is not responsive or is otherwise determined to be unavailable (e.g., after a time out period), enrichment information loader engine 210 is configured to proceed to load at least portions of the successfully received enriched object types into the event logs. In various embodiments, enrichment information loader engine 210 is configured to select at least a portion of an enrichment object type that is received in response to an enrichment request including an extracted value, based on a corresponding context type of the extracted value. The relationship between each extracted value, the extracted value's one or more context types, and the event log(s) associated with each of the extracted value's context types are described in the context mapping that was generated and maintained by context mapping generation engine 206, as described above. Furthermore, enrichment information loader engine 210 is configured to insert the selected portion of the enriched object type back into a location within an event log for which the value was extracted with that context type. In some embodiments, the location within an event log for which the selected at least portion of the enriched object type is to be inserted is also determined based on the extracted value's context type. As such, if the same value was extracted from two event logs within a batch and each time with a different context type, then potentially, enrichment information loader engine 210 is configured to extract two different portions (as determined by the respective context types) of the enriched object type that was returned for the extracted value and then insert the two different portions into the two respective event logs. In some embodiments, enrichment information loader engine 210 is configured to select at least portions of enriched object types and load/insert the selected portions into event logs based on rules, which are stored at context-based enrichment loading rules storage 212. The context-based enrichment loading rules may prescribe which portion (e.g., enrichment fields) to select from an enriched object type corresponding to which value type and where (e.g., which location) within an event log (from which the value according to that value type was extracted) to load/insert the selected portion. In some embodiments, the rules within context-based enrichment loading rules storage 212 can be added to, deleted, and/or updated over time to accommodate additional value types for which enrichment is to performed, modify the loading of enrichment information for a value type, and/or customize loading of enrichment information for different context types corresponding to a value type.

In some embodiments, enrichment information loader engine 210 is configured to perform the context-appropriate enrichment of event logs that were (e.g., temporarily) stored in memory. Context-based enriched event logs transmission engine 216 is configured to send the context-based enriched event logs to downstream services or to a requestor. An example of such a downstream service is a threat detection engine that is configured to evaluate one or more context-based enriched event logs together to assess whether a security threat has likely occurred at the event source system that had originated from the original event logs.

FIG. 3 is a flow diagram showing an embodiment of a process for efficient context-based event log enrichment. In some embodiments, process 300 may be implemented, at least in part, on context-based enrichment server 108 of system 100 of FIG. 1.

At 302, a set of values and corresponding contexts are extracted from a plurality of event logs. In some embodiments, the plurality of event logs comprises a batch of two or more event logs that are collected from one or more event source systems (e.g., SaaS platforms). Values and their corresponding context types are extracted from the two or more event logs according to value types and associated context types as described in the schema configuration. In various embodiments, a mapping is stored for each batch. For example, the mapping describes for each extracted value, the one or more context types with which it was extracted from the plurality of event logs, and the event log(s) from which the value was extracted with the corresponding context type.

At 304, enrichment requests that include the set of values are sent to a set of enrichment target servers. The set of deduplicated values that were extracted from the plurality of event logs are included in enrichment requests that are sent to one or more enrichment target servers, where each enrichment target server is configured to provide supplemental/enrichment information for extracted values of one or more value types. In some embodiments, more than one extracted value (extracted from the two or more event logs) may be included in an enrichment request to a particular enrichment target server. In some embodiments, in the event that enrichment requests (including values extracted from the two or more event logs) are to be sent to two or more enrichment target servers, then the enrichment requests are sent in parallel to the two or more different enrichment target servers.

At 306, respective enrichment responses are received from at least a portion of the set of enrichment target servers. An enriched object type is returned by each enrichment target server in response to each extracted value that was included in the enrichment request that was sent to that enrichment target server. The enriched object type includes one or more enrichment fields that provide additional/supplemental information corresponding to the value type of the extracted value.

At 308, at least a portion of the respective enrichment responses are inserted into a portion of the plurality of event logs based at least in part on the corresponding contexts of the set of values. One or more enrichment fields of each enriched object type that is returned from an enrichment target server are selected based on each context type associated with the extracted value. The selected enrichment fields corresponding to each context type are then inserted into a specified location within each event log from which the extracted value had appeared in that particular context type.

FIG. 4 is a flow diagram showing an example process for extracting values and corresponding contexts from event logs in accordance with some embodiments. In some embodiments, process 400 may be implemented, at least in part, on context-based enrichment server 108 of FIG. 1. In some embodiments, step 302 of process 300 of FIG. 3 may be implemented, at least in part, using process 400.

At 402, a stream of event logs is received from one or more event source systems. Examples of event source systems include SaaS platforms and network devices (e.g., firewalls). A first example event log is from a SaaS platform and documents that a particular user name had logged in to their account at a specified time. A second example event log is from a firewall device and documents the source IP address of a device from which network packets originated.

At 404, the stream of event logs is optionally normalized. In the event that the disparate format(s) of the event logs have not already been normalized, the event logs are normalized to conform to share a uniform format. In some embodiments, the event logs are received at the context-based enrichment server have already been previously normalized.

At 406, a batch of event logs is optionally determined. In some embodiments, a batch of one or more event logs may be determined based on a static rule or dynamic criteria. An example of a static rule is to batch together event logs that are received within each given time interval (e.g., every five minutes). An example of dynamic criteria is to batch together all event logs that are received within 10 seconds of each other. In some embodiments, the event logs that are received at the context-based enrichment server have already been batched by an upstream service (e.g., the event source system).

At 408, for a (next) event log in the batch, value(s) and corresponding context(s) are extracted from the event log. Values corresponding to value types are looked for at specified locations within each event log. If a value corresponding to a particular value type is found in an event log, that value is extracted along with a context type with which it appears within that event log. For example, the context type assigned to an extracted value may be determined based on a field name or location within the event log associated with the extracted value.

At 410, whether there is at least one more event log(s) in the batch is determined. In the event there is at least one more event log(s) in the batch, control is returned to 408. Otherwise, in the event there are no more event log(s) in the batch, control is transferred to 412.

At 412, a mapping that associates extracted values with corresponding contexts and source event logs in the batch is generated. This mapping is stored and later used to load context-appropriate enrichment information corresponding to each extracted value into each source event log from which that value was extracted.

FIG. 5 is a diagram showing an example table including mapping information associated with values that were extracted from a batch of event logs. In some embodiments, table 500 is generated using a process such as process 400 of FIG. 4. Table 500 shows the relationships among values extracted (e.g., according to predetermined value types) from a batch of event logs, one or more context types with which each value was extracted, and identifying information of one or more event logs from which each value was extracted with each corresponding context type. Put another way, table 500 identifies each event log of the batch from which a value was extracted and the context type with which it was extracted. In particular, table 500 indicates that Value A was extracted with two different context types, Context Type A_1 and Context Type A_2. Specifically, Value A was extracted from each of Event Log 123 and Event Log 163 with Context Type A_1. Also, Value A was extracted from each of Event Log 153 and Event Log 239 with Context Type A_2. Furthermore, table 500 indicates that Value B was extracted with two different context types, Context Type B_1 and Context Type B_2. Specifically, Value B was extracted from each of Event Log 123, Event Log 106, and Event Log 171 with Context Type B_1. Also, Value B was extracted from Event Log 092 with Context Type B_2.

As shown in the example of table 500, the same value (e.g., Value A and Value B) may be extracted from more than one source event log in a batch of source event logs. However, each value may be extracted with one or more context types from the source event logs in the batch. Put another way, the same value may appear more than once within the source event logs of a batch but in different context types. Different values with different context types can also be extracted from the same source event log (e.g., both Value A with Context Type A_1 and Value B with Context Type B_1 were extracted from the same event log, Event Log 123). As described above, in various embodiments, while a value may be extracted from more than one source event log in a batch of event logs, they only appear once in an enrichment request to an enrichment target server. Referring back to the example of table 500, while Value A was extracted from four different source event logs in the batch, it will appear only once in an enrichment request to an enrichment target server. Table 500 is stored such that, after enriched object types corresponding to the extracted values are received from enrichment target server(s), context-relevant portions (e.g., select enrichment fields) of the enriched object types can be selected and inserted back into the source event logs that are related to the extracted values identified in the table. To take a specific example, after the corresponding enriched object type is received from an enrichment target server for Value A, a first set of enrichment fields (associated with Context Type A_1) may be selected from the enriched object type to insert/load into Event Log 123 and Event Log 163 and a second set of enrichment fields (associated with Context Type A_2) may be selected from the enriched object type to insert/load into Event Log 153 and Event Log 239.

FIG. 6 is a flow diagram showing an example process for sending enrichment requests to a set of enrichment target servers in accordance with some embodiments. In some embodiments, process 600 may be implemented, at least in part, on context-based enrichment server 108 of FIG. 1. In some embodiments, step 304 of process 300 of FIG. 3 may be implemented, at least in part, using process 600.

At 602, a set of unique extracted values is included into one or more enrichment requests corresponding to respective ones of one or more enrichment target servers. Values that are extracted from a batch of event logs are deduplicated. Then, the corresponding enrichment target server is determined based on the value type of each deduplicated value. Enrichment request(s) for each enrichment target server and that include the corresponding deduplicated values are generated. Put another way, only one instance of a value extracted from a batch of event logs is included in an enrichment request to a corresponding enrichment target server.

At 604, the one or more enrichment requests are at least partially concurrently sent to the one or more enrichment target servers. The enrichment requests that are intended for the same enrichment target server can be concurrently sent to that server. Furthermore, the enrichment requests that are intended for the different enrichment target servers can be concurrently sent to those servers.

At 606, whether response(s) to the one or more enrichment requests are complete is determined. In the event that the responses to the one or more enrichment requests have been completely received, process 600 ends. Otherwise, in the event that the responses to the one or more enrichment requests have not been completely received, control is returned 606 after a wait. In some embodiments, only after a response is received from each enrichment target server to which an enrichment request was sent are the responses processed (e.g., used to enrich the batch of event logs). In some embodiments, if after a timeout period elapses, even if at least one response is not received from an enrichment target server, then the remaining responses are processed. In some embodiments, a response comprising an enriched object type that includes additional/supplemental/enrichment information is returned for each unique value that was included in an enrichment request. For example, if extracted values userID_123 and userID_456 were both sent to an enrichment target server that provided enriched user objects, then a first enriched user object corresponding to userID_123 and a second user enriched object corresponding to userID_456 would be returned.

FIG. 7 is a diagram showing an example process enriched user object in accordance with some embodiments. In the example of FIG. 7, an enrichment request that included a value extracted from a batch of event logs, the userID of “123456,” was sent to an enrichment target server that is associated with providing user-related enrichment information. For example, this enrichment target server includes a database with user-related information that was gathered from resolving information obtained from different sources (e.g., different SaaS platforms) that are associated with the same individual/user. In some embodiments, the context-based enrichment server may include in an enrichment request a set of enrichment fields that are requested from an enrichment target server with respect to an extracted value and in response, the enrichment target server is configured to supply values to those of the enrichment fields that the server is authoritative on (e.g., has more than a threshold amount of confidence that those enrichment values correspond to the provided extracted value). In the example of FIG. 7, enriched object type 700 comprises an enriched user object that was returned by an enrichment target server for the extracted userID of “123456.” Enriched object type 700 includes several provided enrichment fields that correspond to the same user that is associated with userID “123456.” Such enrichment fields include the user's full name (user.identity.full_name: Bob Smith), the user's user name (user.name: Bsmith2002), the user's roles (user.roles: member, admin, guest, guest), whether the user has elevated permission (user.target.identity.elevated: TRUE), the user's email (user.email: Bsmith2002@acme.com), and the groups to which the user belongs (user.groups: Group_Acacia, Group_Cedar).

FIG. 8 is a flow diagram showing an example process for loading enrichment information into event logs in accordance with some embodiments. In some embodiments, process 800 may be implemented, at least in part, on context-based enrichment server 108 of FIG. 1. In some embodiments, step 308 of process 300 of FIG. 3 may be implemented, at least in part, using process 800.

At 802, for a (next) extracted value in a set of values extracted from a batch of event logs, collected enrichment information associated with the extracted value is obtained. A mapping (e.g., such as table 500 of FIG. 5) that describes the relationships among values extracted from a batch of event logs, one or more context types with which each value was extracted, and identifying information of one or more event logs from which each value was extracted with each corresponding context type is obtained from storage. The enriched object type corresponding to an extracted value that is tracked in the mapping is obtained.

At 804, a (next) context type corresponding to the extracted value is determined according to a stored mapping. From this mapping, a context type corresponding to the current extracted value under consideration is determined.

At 806, a (next) event log mapped to the context type is determined. An event log that maps to the current context type corresponding to the current extracted value under consideration is determined from the mapping.

At 808, at least a portion of the collected enrichment information associated with the extracted value is loaded into the event log based on the context type. At least a portion (e.g., a set of enrichment fields) from the enriched object type is selected based on the current context type and predetermined context-based enrichment loading rules. This selected set of enrichment fields is then loaded/inserted into a specified location of the current event log. In some embodiments, the event log comprises a JSON file and the selected set of enrichment fields is inserted into the JSON file at a specified location.

At 810, whether there is at least one more event log that is mapped to the context type is determined. In the event that there is at least one more event log that is mapped to the context type in the stored mapping, control is returned to 806. Otherwise, in the event that there are no more event logs that are mapped to the context type in the stored mapping, control is transferred to 812. Each event log that maps to the current context type in the mapping is iterated through (e.g., across steps 806 through 810) to ensure that context-based loading of enrichment fields from the enriched object type corresponding to the extracted value is performed with respect to each event log that maps to that context type.

At 812, whether there is at least one more context type that is mapped to the extracted value is determined. In the event that there is at least one more context type that is mapped to the extracted value in the stored mapping, control is returned to 804. Otherwise, in the event that there are no more context types that are mapped to the extracted value in the stored mapping, control is transferred to 814. Each context type that maps to the current extracted value in the mapping is iterated through (e.g., across steps 804 through 812) to ensure that context-based loading of enrichment fields from the enriched object type corresponding to the extracted value is performed with respect to the event log(s) that map to every such context type.

At 814, whether there is at least one more extracted value is determined. In the event that there is at least one more extracted value in the stored mapping, control is returned to 802. Otherwise, in the event that there are no more extracted values in the stored mapping, process 800 ends. Each extracted value in the mapping is iterated through (e.g., across steps 802 through 814) to ensure that context-based loading of enrichment fields from the enriched object type corresponding to each extracted value is performed with respect to each event log that maps to that extracted value.

FIG. 9 is a diagram showing an example schematic of a system for efficient context-based event log enrichment in accordance with some embodiments. In the example of FIG. 9, orchestrator 902 (e.g., which can be used to implement, at least in part, context-based enrichment server 108 of FIG. 1) receives event logs 904 from one or more event source systems (not shown). Orchestrator 902 determines that one or more of such event logs are part of a batch. Orchestrator 902 extracts values and context types 908 from the batch of event logs in accordance with the predetermined value types and/or corresponding locations are described in schema configuration 906. Orchestrator 902 generates and stores a mapping that describes the relationships among the extracted values, the one or more context types with which each value was extracted, and identifying information of one or more event logs from which each value was extracted with each corresponding context type. Orchestrator 902 identifies which enrichment target server (e.g., enrichment target server 912 or enrichment target server 916) to send an instance of each value to that was extracted from the batch of event logs. Next, orchestrator 902 concurrently sends enrichment requests to both enrichment target server 912 and enrichment target server 916, where the request(s) to each of such enrichment target servers includes the extracted values that are to be enriched by that particular enrichment service.

In a specific example, enrichment target server 912 provides user information enrichment (e.g., by storing and searching through gathered user enrichment information stored at database 914) and enrichment target server 916 provides IP address enrichment (e.g., by storing and searching through gathered IP address enrichment information stored at database 918). As such, orchestrator 902 would send extracted values corresponding to the value types of user ID, user name, or email address to enrichment target server 912 and in response, receive a result describing an enriched user object type corresponding to each such extracted value. As mentioned above, example enrichment fields within an enriched user object include full name, email, user ID, role(s), and group memberships. Similarly, orchestrator 902 would send extracted values corresponding to the value types of user ID, user name, or email address to enrichment target server 912 and in response, receive an IP address enriched type corresponding to each such extracted value. As mentioned above, example enrichment fields within an enriched iP address object include enrichment fields such as country, domain, number, organization name, type, city name, country code, geographic coordinate, postal code, region name, and time zone.

After receiving the enriched object types from enrichment target server 912 and enrichment target server 916 corresponding to each extracted value, orchestrator 902 refers to the stored mapping and then loads context-relevant portions of each enriched object type into each event log that is mapped to that extracted value. By loading/inserting context-relevant portions of each enriched object type into each event log, orchestrator 902 outputs context-based enriched event logs 910.

FIGS. 10A and 10B describe examples of two event logs before and after context-based enrichment.

FIG. 10A shows two example event logs prior to context-based enrichment. Event Log with ID 364 (hereinafter “Event Log 364”) was received at the context-based enrichment server (e.g., context-based enrichment server 108 of FIG. 1) from the event source system “Storeco,” was generated in response to the event type of “permission update,” the event was initiated by an actor user associated with the user name of “J.martin.89,” and the target user of the event was associated with the user name of “Bsmith2002.” Event Log with ID 371 (hereinafter “Event Log 371”) was received from the event source system “Payrollr,” was generated in response to the event type of “login,” and the event was initiated by an actor user associated with the user name of “Bsmith2002.” For example, each of Event Log 364 and Event Log 371 can be implemented using JSON. In the example of FIG. 10A, both Event Log 364 and Event Log 371, which were collected from different source systems and then included in the same batch of event logs, have already been normalized at the context-based enrichment server according to a uniform format. After the content of each Event Log 364 and Event Log 371 were compared to a schema configuration to extract for values corresponding to predetermined value types, (at least) the value of “Bsmith2002” was extracted by the context-based enrichment server (e.g., using a process such as process 400 of FIG. 4) from Event Log 364 with the context type of “target user” and (at least) the value of “Bsmith2002” was extracted from Event Log 371 with the context type of “actor user.”

While the value of “Bsmith2002” was extracted from two different event logs within a batch, they were extracted from each event log with a different context type. The relationships between extracted value “Bsmith2002,” each of the context types with which it was extracted with, and each event log from which “Bsmith2002” was extracted with each context type may resemble the format of mapping table 500 of FIG. 5, as described above. However, in accordance with various embodiments described above, the value of “Bsmith2002” need only be sent once by the context-based enrichment server to a corresponding enrichment target server (e.g., using a process such as process 600 of FIG. 6) that is configured to provide user-related enrichment information (e.g., return enriched user objects).

FIG. 10B shows two example event logs after context-based enrichment. To continue the enrichment example that was previously described in FIG. 10A, after the value of “Bsmith2002” was extracted from both Event Log 364 and Event Log 371, albeit with different context types, the value “Bsmith2002” was included in an enrichment request that was sent by the context-based enrichment server to a user-related enrichment target server. While not discussed in FIGS. 10A and 10B, the value “Bsmith2002” could have been included in the enrichment request to the user-related enrichment target server along with zero or more other user related values that were also extracted from the same batch of event logs. Also, while not discussed in FIGS. 10A and 10B, the value “Bsmith2002” could have been included in an enrichment request that could have been concurrently sent along with another enrichment request (to a different enrichment target server) including value(s) of different value types that were extracted from the same batch of event logs.

In response to receiving the value “Bsmith2002,” the recipient user-related enrichment target server returned to the context-based enrichment server a corresponding enriched user object. An example of such an enriched user object corresponding to the value of “Bsmith2002” is enriched user object 700 that is shown in FIG. 7, above. A corresponding subset of enrichment fields is selected by a context-based enrichment server (e.g., using a process such as process 800 of FIG. 8) from enriched user object 700 corresponding to each context type with which “Bsmith2002” was extracted. Then, the selected enrichment fields associated with each context type are inserted/loaded into (e.g., a predetermined location within) each event log from which “Bsmith2002” was extracted with that context type (as described in a stored mapping). In the example of FIG. 10B, the inserted context-based enrichment fields are shown in bolded text. For the context type of “target user,” the enrichment fields “user.target.id: 123456, “user.target.identity.full_name: Bob Smith,” and “user.target.groups: Group_Acacia, Group_Cedar” were selected from enriched user object 700 (e.g., in accordance with context-based enrichment load rules) and then inserted into Event Log 364 below the original field of “user.target.name: Bsmith2002.” For the context type of “actor user,” the enrichment fields “User.id: 123456, “user.identity.full_name: Bob Smith,” and “user.roles: member, admin, guest, guest” were selected from enriched user object 700 (e.g., in accordance with context-based enrichment load rules) and then inserted into Event Log 371 below the original field of “user.name: Bsmith2002.” The context-based enriched Event Log 364 and Event Log 371 as shown in FIG. 10B, which have been enriched by at least the context-relevant enrichment information related to the extracted value of “Bsmith2002,” may then be stored and/or transmitted to a downstream service such as, for example, threat detection.

As shown in various embodiments described herein, event logs can be gathered into a batch and then values and their corresponding context types can be extracted from the batch of event logs. The relationships among the extracted values, their corresponding context types, and the event logs from which the values were extracted with respective context types can be tracked in a stored mapping. The unique instances of the extracted values are concurrently sent to one or more enrichment target servers that are configured to provide different types of enrichment information. The responses from such enrichment target servers include enriched object types, from which context-aware enrichment fields are extracted for each extracted value and then loaded into the event log(s) from which that value was extracted. Advantageously, for example, even if the same value appears multiple times within a batch of event logs, that value will only once within a context enrichment request and the obtained enrichment information can then be inserted in within multiple source event logs in a context-appropriate manner.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an event log interface configured to receive a plurality of event logs from one or more event source systems; and
one or more processors configured to:
extract a set of values and corresponding contexts from the plurality of event logs;
send respective enrichment requests that each includes the set of values to a set of enrichment target servers;
receive respective enrichment responses from at least a portion of the set of enrichment target servers; and
insert at least a portion of the respective enrichment responses into a portion of the plurality of event logs based at least in part on the corresponding contexts of the set of values.

2. The system of claim 1, wherein the one or more processors are further configured to determine a batch of two or more event logs.

3. The system of claim 2, wherein the batch of two or more event logs is determined based at least in part on a predetermined batching rule.

4. The system of claim 1, wherein the one or more processors are configured to extract the set of values based at least in part on one or more predetermined value types described in a schema configuration.

5. The system of claim 1, wherein the one or more processors are further configured to generate and store a mapping that relates the set of values to the corresponding contexts and event logs from which the set of values were extracted with the corresponding contexts.

6. The system of claim 1, wherein the set of values comprises unique values.

7. The system of claim 1, wherein the respective enrichment requests are sent at least partially in parallel to each other.

8. The system of claim 7, wherein the set of enrichment target servers comprises a first enrichment target server and a second enrichment target server, wherein the respective enrichment requests include a first enrichment request to the first enrichment target server and a second enrichment request to the second enrichment target server, and wherein the first enrichment request and the second enrichment request are sent at least partially in parallel to each other.

9. The system of claim 8, wherein the first enrichment target server is configured to provide user-related information and the second enrichment target server is configured to provide Internet Protocol (IP) address related information.

10. The system of claim 1, wherein to insert the at least portion of the respective enrichment responses into the portion of the plurality of event logs based at least in part on the corresponding contexts of the set of values comprises to:
determine a first enrichment response corresponding to a first value;
select a first portion of the first enrichment response corresponding to a first context associated with the first value; and
insert the first portion of the first enrichment response into a first event log from which the first value was extracted with the first context.

11. The system of claim 10, wherein the one or more processors are further configured to:
select a second portion of the first enrichment response corresponding to a second context associated with the first value, wherein the first portion is different from the second portion; and
insert the second portion of the first enrichment response into a second event log from which the first value was extracted with the second context.

12. The system of claim 1, wherein the one or more processors are further configured to send the portion of the plurality of event logs with the inserted at least portion of the respective enrichment responses to a threat detection service.

13. A method, comprising:
extracting a set of values and corresponding contexts from a plurality of event logs;
sending respective enrichment requests that each includes the set of values to a set of enrichment target servers;
receiving respective enrichment responses from at least a portion of the set of enrichment target servers; and
inserting at least a portion of the respective enrichment responses into a portion of the plurality of event logs based at least in part on the corresponding contexts of the set of values.

14. The method of claim 13, further comprising determining a batch of two or more event logs.

15. The method of claim 13, further comprising extracting the set of values based at least in part on one or more predetermined value types described in a schema configuration.

16. The method of claim 13, further comprising generating and storing a mapping that relates the set of values to the corresponding contexts and event logs from which the set of values were extracted with the corresponding contexts.

17. The method of claim 13, wherein the set of values comprises unique values.

18. The method of claim 13, wherein the respective enrichment requests are sent at least partially in parallel to each other.

19. The method of claim 18, wherein the set of enrichment target servers comprises a first enrichment target server and a second enrichment target server, wherein the respective enrichment requests include a first enrichment request to the first enrichment target server and a second enrichment request to the second enrichment target server, and wherein the first enrichment request and the second enrichment request are sent at least partially in parallel to each other.

20. A computer program product embodied in a non-transitory computer readable medium and comprising computer instructions for:
extracting a set of values and corresponding contexts from a plurality of event logs;
sending respective enrichment requests that each includes the set of values to a set of enrichment target servers;
receiving respective enrichment responses from at least a portion of the set of enrichment target servers; and
inserting at least a portion of the respective enrichment responses into a portion of the plurality of event logs based at least in part on the corresponding contexts of the set of values.
